(19) United States
(12) Patent Application Publication
(10) Pub. No.: US 2020/0093143 A1
(43) Pub. Date: Mar. 26, 2020

(54) DOUGH MATERIAL CONTAINING CRUMBS OF A PREMADE BAKED PRODUCT

(71) Applicant: Hama Foodservice GesmbH, Hof bei Salzburg (AT)

(72) Inventors: Hans Mandl, Pfunds (AT); Rudolf Haindl, Salzburg (AT)

(21) Appl. No.: 16/655,829

(22) Filed: Oct. 17, 2019

Related U.S. Application Data
(63) Continuation of application No. PCT/AT2017/060341, filed on Dec. 21, 2017.

(30) Foreign Application Priority Data
Apr. 19, 2017 (AT) A 50316/2017

(51) Int. Cl. A21D 13/31; A21D 10/00; A21D 17/00; A21D 2/16

(52) U.S. Cl. CPC A21D 13/31; A21D 2/16; A21D 17/002; A21D 10/00

(57) ABSTRACT

A dough for the production of an outer casing for a snack product including the ingredients: crumbs of a previously made bakery product; fat component; liquid component; emulsifier; and raising agent, wherein the proportion of the crumbs is between 20% by weight and 60% by weight.

The invention concerns a dough for the production of an outer casing for a snack product including crumbs of a previously made bakery product, liquid, emulsifiers, raising agent as well as a snack product having an outer casing produced from the dough and crisped up and a filling material and a method of producing a snack product.

In the presentday, generally stressful working environment it is frequently usual at midday to eat only a snack product which can be quickly acquired but is nonetheless tasty and as far as possible freshly prepared. Particularly in fast food restaurants but increasingly also in bakeries, pastry shops and supermarkets as well as in hotels, restaurants and in the catering trade previously made snack products are freshly crisped up in order to meet the customer needs for a freshly prepared product. At the same time both in supermarkets, bakeries and pastry shops but also in fast food restaurants enormous amounts of bakery products, in particular bread, are thrown away daily because bakery products are often conceived to be “old” by the customers after just one day after they have been produced—although in themselves they are palatable without any problems—and are therefore no longer accepted.

WO 94/07369 discloses a foodstuff produced from dough with a sweet or spicy filling and possibly a topping, with the dough being pre-cooked. The foodstuff is to be heated in a microwave oven for final consumption. So as to permit the production of a crispy case the surface of the dough is provided with a coating of nuts, grains, seeds or crumbs. This however does not provide a possible use for large amounts of crumbs nor is it possible to produce an outer casing for a snack product in a simple fashion.

US 2014/0154362 discloses a confectionery item having a chocolate covering, wherein the filling comprises dried sweet crumbs mixed with a fat-liquid matrix. The confectionery item represents a finished food. There is no teaching of a dough for the production of an outer casing for a snack product.

EP 1283012 concerns an ice confectionery (sweet chocolate praline) having a casing in which a frozen filling is disposed. The casing contains cookie crumbs of cookies which have already been baked. A binding agent in the form of a syrup which upon mixing with the crumbs is deposited around the surface thereof in the form of a coating results in a mass which can be shaped in the cold state and which is warm-dried for hardening purposes. The basic starting material of the ice confectionery does not serve as a dough for the production of an outer casing for a snack product in accordance with the present invention, but only for the production of two sandwich halves, between which an iced cream can be arranged.

EP 1658773 concerns a method of producing a snack product from crumbs which are hot-shaped to give a snack carrier by means of a pressing mould. A sweet or spicy filling is then arranged in the snack carrier. The aim of that invention is to provide a long-lasting filled snack product. So that it is possible to dispense with glycerin for the dough casing bread crumbs with a high level of water activity are used. Alternatively sweet crumbs can also be employed. The crumb proportion in that case is over 80%, thereby producing an extremely firm and very dry dough which is shapable only with a pressing mould. Simple production of a dough outer casing for a snack product is not possible.

DE 20 2011 105 658 concerns a composition for the production of a spicy cover layer for a dish, the composition containing crumbs. Wth the cover layer the dish can be provided with a spicy casing. There is no teaching of a dough which serves to produce an outer casing for a snack product.

With that background in mind the object of the invention is to provide a dough for an outer casing for a snack product, which on the one hand permits further use of bakery products which in themselves are no longer sellable and which on the other hand represents a starting base for a snack product which can be quickly cooked or crisped up on site. For the present invention the bottom is to be interpreted as a part of the outer casing. The outer casing therefore represents a continuous casing, by which a filling material can be at least partially enclosed.

That object is attained by a dough having the features of claim 1.

One of the main constituents of the dough comprises dried or fresh crumbs which are produced from previously made baked goods or pastries. In particular as the previously made bakery products, it is possible to use those baked goods which in themselves can be enjoyed without any problem but which can no longer be sold or can only be sold at major price discounts, for example bread from the day before. As a result the left-overs which occur in supermarkets, bakeries, patisseries and fast food restaurants no longer have to be destroyed and can continue to be available for the nutrition cycle for further processing to give high-quality and tasty snack products.

In the case of spicy applications, that is to say when dealing with snack products with a spicy filling arranged within the outer casing, it is possible to use for example whole grain, white bread, rye bread or pumpernickel crumbs as the crumbs. In the case of sweet applications, that is to say in relation to snack products with a sweet filling within the outer casing, it is possible to use for example biscuit, brioche or cookie crumbs as the crumbs. Mixtures of various kinds of crumbs can also be used both in relation to spicy and also in relation to sweet applications.

A further positive effect which is brought about by the use of crumbs instead of conventional flour as the dough base is the waiting time, which is not required, in the proofing cabinet, as the flavourful ripening of the aromas has already taken place due to the pre-baked crumbs. That considerable advantage in production affords a potential in time saving of up to 20% to 25% in production.

Previously made bakery products like for example bread or biscuit which must be of a certain hardness serve as the starting substances for the crumbs. What are ideal therefore are somewhat older bakery products which in themselves are edible without any problem but are no longer sellable, for example bread from the day before. Bakery products which are highly suitable for the purpose of the invention are those which upon strength measurement in accordance with AACC 74-09, at which the compression of the bakery product under the action of a ram is less than 20%, preferably less than 10%. In the case of greater compression the bakery product is excessively soft and homogeneous granulation of the crumbs cannot be guaranteed, which is a disadvantage in particular for machine production.

For production of the crumbs from the previously made bakery products use is made of equipment like for example grinders, mixers (blenders) or micro-cutters. A grain size of between 14 mesh (corresponds to a grain size of 1.41 mm) and 45 mesh (corresponds to 0.354 mm) is particularly suitable for the purposes of the invention. Wth excessively coarse grinding of less than 5 mesh (corresponds to a grain size of more than 4 mm), besides optical detriment losses of quality also occur. In addition, with excessively coarse granulation, a higher percentage of liquid has to be added. With excessively fine grinding of more than 60 mesh (corresponds to a grain size of less than 0.25 mm) the dough becomes too mushy, whereby machine processing becomes impossible.

In addition a liquid component is added to the dough, the amount of which depends on the binding capacity of the crumbs used as well as the amount of added fat component and the added emulsifier. The fat component and the emulsifier contain water and thus also contribute to increasing the proportion of water in the dough. The specifically added liquid component can be products like milk, cream, water and/or fruit juices.

The added liquid component serves to increase the proportion of water in the dough. The proportion of water in the dough has the purpose of making the dough pumpable. In addition the aim of the proportion of water is to activate the pre-cooked starch which is already contained in the crumbs. Besides coagulated gluten the gelatinised starch forms the basis for binding of the dough.

To enhance the binding capacity of the dough the dough also has an emulsifier added thereto. The emulsifier used can be products like pre-produced sauce base and/or whole egg, which enjoy excellent binding capacity. In particular that applies to a sauce base comprising cream and starch. Such a sauce base like whole egg contains natural emulsifiers so that it is possible to dispense with the addition of artificially produced emulsifiers which are food ingredients labeled by the E-numbers and which are frequently used in convenience food products.

In an embodiment of the invention a particularly high binding effect in respect of the added fat component with simultaneous loosening of the dough is achieved by an emulsifier in the form of a combination of whole egg which contains lecithin and a sauce base which contains a combination of tapioca and waxy maize starch. Both kinds of starch have emulsifying properties and can thus enhance the action of the emulsifier. The ingredients for the dough can disperse and bind to form a homogeneous mass.

Besides the property of being a flavour carrier the added fat component also serves to avoid the outer casing being moistened after baking, whereby the quality and shelf life of the snack products according to the invention is enhanced. Besides the addition of the fat component, which is effected for example in the form of products like butter, margarine and/or oil, the added liquid component and the added emulsifier may also contain a proportion of fat which additionally enhances the action of the added fat component. That applies in particular for an emulsifier in the form of a previously produced sauce base, comprising cream and starch, wherein in the case of a high proportion of cream the emulsifier can have between 10% by weight and 20% by weight of fat.

In addition a raising agent for loosening the dough is added thereto. Finally spices and herbs or sugar can optionally also be added to the dough. The dough is produced by mixing and stirring together the ingredients, in which respect machine or manual kneading can additionally be involved.

According to the invention the proportion of crumbs is between 20% by weight and 60% by weight, preferably between 22% by weight and 35% by weight. A range of between 25% by weight and 30% by weight can also be provided. In that way on the one hand considerable amounts of previously made bakery products in the form of crumbs, that is to say in rubbed form, can be further processed, in which case the dough, because of the crumbs and the added liquid component and the added emulsifier is of a soft consistency and can accordingly be easily worked.

A crumb proportion of over 60% by weight would however excessively gelatinise the dough and not do justice to the quality requirements of consumers. In addition the dough would be of an excessively high viscosity and the formation of an outer casing by arranging the filling in the dough would no longer be possible. That applies even when the filling is urged into the dough with a ram or the frozen filling itself functions as a ram.

It has surprisingly been found that, in contrast to conventional flour products, there is no risk of excessive gelatinisation as long as the proportion of crumbs is not too high. The dough can therefore be shaped to form an outer casing which jointly with the bottom which is also to be counted as part of the outer casing after the baking operation is highly suited as a sealed casing for the filling arranged within the outer casing. The fact of the gelatinisation not being excessive ensures that after the baking operation the outer casing does not have any splits from which the filling could escape. That applies in particular when the ready-to-eat snack product contains an at least partially fluid or pasty filling.

For the outer casing to be produced from the dough it is advantageous if the crumbs are of a uniform grain size. Any variations in the grain size or the fineness of the crumbs can be compensated by an increased or reduced addition of liquid. It is advantageous for a uniform quality if the crumbs used can be specified, the above-mentioned strength test and grinding with a specified grinder and optionally a sieving operation following same with a given mesh size serving for that purpose.

The dough can be mixed, stirred and kneaded by means of a bishop hook or dough hook or similar mixing devices. In spite of the fact that there is no danger of excessive gelatinization by virtue of the crumb proportion the preparation times should be kept short so that the dough does not become excessively gelatinised as a result of kneading, stirring and mixing. For example preparation times for the dough can be only between two and three minutes. Such short preparation times are also advantageous in terms of an increase in efficiency in respect of industrially produced snack products.

After the dough has been produced by mixing, stirring and possibly kneading of the dough starting materials an outer casing is formed therefrom, which serves to receive a tasty filling core consisting of a spicy or sweet material and also after crisping holds the in part liquid or pasty filling, wherein the bottom produced from the same dough is also to be considered as being part of the outer casing. In addition the outer casing serves as a side dish. By virtue of the starting substances the dough is captivating due to its looseness and lightness. It is suitable for freezing and the dough can be consumed cold as well as hot. Further advantageous configurations of the invention are defined in the appendant claims.

In an embodiment of the invention the added liquid component comprises water, milk, cream and/or fruit juices. The proportion of water in the dough can be between 25% by weight and 50% by weight. The proportion of the added liquid component can be between 10% by weight and 40% by weight, preferably between 20% by weight and 30% by weight. In the case of milk as the added liquid component that with a water proportion of over 90% crucially contributes to the proportion of water in the dough. The added emulsifier also has a high proportion of water. A sauce base consisting of cream and starch can have a proportion of water of about 70%. Whole egg which can also be added as an emulsifier has a proportion of water of 74.10%.

In a preferred embodiment of the invention the emulsifier comprises whole egg and/or a sauce base. The proportion of emulsifier in the dough can be between 10% by weight and 45% by weight, preferably between 10% by weight and 30% by weight.

The sauce base includes a fat proportion and a starch proportion. The fat proportion can be between 5% by weight and 30% by weight, the starch can be between 1% by weight and 10% by weight. Preferably there is a fat proportion of 15% by weight and a starch proportion of 3% by weight. In a preferred embodiment the sauce base comprises the fat proportion and the starch proportion. The fat proportion can be in the form of cream. The starch proportion can be in the form of native starch.

In a further embodiment of the invention the added fat component comprises butter, margarine and/or oil. The proportion of fat in the dough can be between 8% by weight and 30% by weight.

The dough according to the invention and the snack product produced therefrom are particularly intended to be produced by machine and then made ready for consumption on site in fast food restaurants or in supermarkets. In the meantime there is a need for storage which does not result in an adverse effect on the dough or the snack product. Wth cool storage at a temperature of between 0° C. and 5° C. or upon freezing at around −18° C. retrogradation however occurs, with the starch which is gelatinised in production reverting. In that respect it has been found in an embodiment of the invention that that process can be impeded by adding an emulsifier comprising a combination of whole egg and a mixture of cream and, preferably native, starch. The mixture of cream and starch represents a sauce base in accordance with the invention.

In case of a combination of whole egg and sauce base the proportion of full egg in the dough can be between 10% by weight and 35% by weight, preferably between 15% by weight and 30% by weight. The proportion of sauce base in the dough can be for example between 10% by weight and 20% by weight. In an embodiment however the emulsifier in terms of weight can also be composed in equal parts of whole egg and the above-described sauce base, preferably comprising a mixture of cream and starch. It is particularly preferred if the starch of the sauce base is composed of, preferably native, tapioca starch and preferably native, waxy maize starch, in which case once again a composition in equal parts can be used. A possible composition of the sauce base comprises 97% of cream with a fat proportion of 15% and 1.5% of native tapioca starch and 1.5% of native waxy maize starch. An example of such a sauce base is a QimiQ® sauce base.

With such an emulsifier the starch of the sauce base, together with the chicken protein which contributes to stability without breaking down and the pre-cooked starch from the crumbs forms a gelatinisation structure which remains the same and stable and which even upon prolonged storage does not break down or revert. In particular the fat proportions are accommodated in that structure and can be segregated with difficulty.

In a preferred embodiment of the invention the raising agent of the baking mixture is a chemical baking raising agent, preferably baking powder. The proportion of baking agent can be between 0.5% by weight and 2% by weight.

In the case of a chemical raising agent it is possible to dispense with the addition of biological baking raising agent. In particular it is possible to dispense with yeast. That is advantageous for the invention insofar as the fermentation process which is linked to biological raising agents, in particular yeast, is eliminated. In that way the thickness of the outer casing, in particular in the lateral region, can be better adapted to different shapes. In addition this involves a time saving in production by about 20% to 25%, which in turn is advantageous in particular in industrial production.

The invention further concerns a snack product with a crisped-up outer casing made from a dough as described hereinbefore and a filling.

The portion size of the snack product can range for example from 60 g to 350 g, preferably from 130 g to 280 g. Larger portions of up to 1000 g are also possible. Depending on the respective size the snack product according to the invention can be offered as a between-meals snack or as a finished lunch or also as finger food. In that case the baked outer casing serves as a side order. In that respect the filling, depending on the kind of crumbs of the dough, can be spicy (fish, meat, vegetables, etc) or sweet (fruit, chocolate, vanilla cream, etc). The snack product can be stored frozen, in which respect a shelf life of 6 months is possible without any problem. In the fresh state cooled storage of 3 to 5 days is possible without any problem. If the outer casing produced from the dough, with the filling arranged therein, is frozen, then only heating up is still required to give the snack product. The frozen snack products can be easily heated using different equipment like a microwave, a hot air oven or a high speed oven. Fluctuations in quality are thus excluded.

The outer casing with the filling therein can be pre-baked prior to freezing. For finishing the snack product from the frozen state it is only necessary to implement regeneration in an oven or a high speed oven or in the microwave. The ready-to-eat snack product can be kept warm without any difficulty over a prolonged period, for example 4 to 5 hours, without any noticeable moisture loss, and is therefore ideally suitable for sale in supermarkets and fast food restaurants as well as hotels, restaurants and in catering. The sweet products can be consumed cold or hot.

The range of filling extends from vegetables, meat, fish, fruit, chocolate and vanilla fillings, culminating in classics from international cuisine. In particular regional and seasonal particularities can also be taken into consideration at any time. A corresponding diversity prevails in the choice of crumbs which can be used.

The invention further concerns a method of producing a snack product from a dough, in particular as described above, with the following steps:
producing a dough,
producing a filling,
introducing the dough into a mould, and
arranging the filling on the dough.

According to the invention it is provided that an outer casing for receiving the filling in the dough is formed by the arrangement of the filling. In that respect, besides a lateral outer casing region, the outer casing also has a bottom which is also to be taken as part of the outer casing. That permits particularly simple and efficient production because there is no need for separate shaping of the outer casing, in particular the lateral region thereof.

The arrangement of the filling thus produces a depression in the dough and provides for displacement of the pasty dough so that a sufficiently high lateral outer casing region is formed, by which the filling is held after baking in the interior of the outer casing and thus in the interior of the snack product. The filling can be spicy or sweet as described above depending on the dough.

The method according to the invention can be used particularly advantageously for a dough as defined in claims 1 to 9, which is in part liquid or pasty and nonetheless sufficiently stable in order on the one hand to be easily displaced by the filling arranged thereon and on the other hand to hold the filling securely in the snack product. The dough can be prepared during or after mixing of the ingredients in magnetic stirrers by means of a bishop hook or dough hook or similar mixing devices. The preparation times can be very short, for example only about 2 to 3 minutes so that the starch of the crumbs does not become too slimy. The consistency of the dough is such that simple and uncomplicated filling by way of a piston filler or the like is possible. The dough is placed in the centre of a mould provided for same, which can comprise paper or cardboard, metal like for example stainless steel or aluminium, ceramic materials like for example porcelain or a plastic like for example silicone. The important thing is that the material must correspond to the baking processes. The different materials of the moulds can have effects on the baking time.

After the dough has been meteredly introduced in a mould and after shaping of the dough by the filling it is possible immediately to go over to the baking process, in particular if it is possible to dispense with biological baking raising agents in the dough. It is easily possible to achieve automation in production by virtue of the simple dough guidance action and the metered introduction of the dough into the mould without any problem and the re-distribution thereof by virtue of the arrangement of the filling. That leads to a better pricing structure, in which respect, with a dough as described above, over-productions of bakery products can additionally be appropriately further used. In addition under such conditions the dough is considerably less subjected to a thermal loading than conventional bread doughs. The central introduction of the filling on the dough gives rise to a uniform edge which in the baking operation is externally crispy and internally soft.

It is preferably provided that the mould is in the form of a peripheral surface of a cylinder or prism. The sufficiently pasty dough can very well adapt to moulds. In that way the outer casing of the snack product is then also of a cylindrical or prismatic, upwardly open shape.

The increase in volume takes place purely in the baking oven. In that respect the different kinds of oven like for example rack ovens, fan ovens and so forth do not play any part.

In a preferred embodiment of the method according to the invention the filling is arranged in the frozen state on the dough and then pressed into the mould. Particularly if it originally involves a fluid filling that can be arranged for example in a casing skin. Then, for arrangement in the dough, suitable portions are cut off the frozen filling. The frozen filling functions as a ram by which the pasty dough is displaced and, by virtue of the mould which prevents the dough from escaping, an outer casing is formed, which is sufficiently strong and which also has a sufficiently high lateral casing region to hold the filling in the snack product after the baking operation.

Arranging the filling in the frozen state has the advantage that a snack product with a filling which is partly liquid or pasty in the ready-to-eat state can be produced. An outer casing is formed by the arrangement of a frozen filling made from liquid or pasty components. The frozen filling is thawed out during the baking process and as a result—depending on the ingredients of the filling—becomes fluid or pasty. In that case a dough as recited in claims 1 to 9 is of particular advantage as, because of the crumb proportion, the partly fluid or pasty filling is prevented from escaping. In that way it is possible to produce a snack product which can be quickly and easily made ready to eat and can have a tasty, partly fluid or pasty filling core.

Arranging the frozen filling core in the dough in that respect also gives the advantage that the outer casing is sufficiently baked until the filling is thawed in order to reliably arrange a thawed filling core which has fluid or pasty components in the ready-to-eat snack product without fluid or pasty components issuing through the outer casing. Partially fluid or pasty fillings can be frozen in any forms so that almost any forms can be implemented for the snack product. That is in turn advantageous in particular for a dough as set forth in claims 1 to 9, which is sufficiently pasty and which can also adapt very well to different forms.

Arranging a filling in the frozen state also has the advantage that no standing times are required, the dough with the filling arranged therein can be put directly into the oven to make the snack product ready to eat.

It is however also possible to push in the filling when the filling is fresh. In this case it may possibly be necessary to use a separate ram which holds the filling together while it is being pressed in. Once again, the outer casing is formed by virtue of the filling being pressed into the pasty dough as the mould prevents the dough from escaping.

The aim in the preparation operation is for an oven temperature of 200° C. to 220° C., the baking time depending on the size and thickness of the casing and the filling may be between 10 and 25 minutes, in which respect markedly shorter baking times of 1 to 2 minutes or 5 to 6 minutes respectively can be involved in high speed ovens and in a microwave. The core temperature of the snack product should be about 85° C. to 90° C. to comply with the hygiene guidelines and shelf life requirements by pasteurisation. The filling has to be sufficiently heated.

In an embodiment of the invention, in regard to weight, the casing can have a ratio to the filling of about 60 to 40. Other and in particular higher percentages are also possible however for the filling.

After the baking and cooling process the snack product is moisture-tightly packaged and frozen. Film packagings in particular are suitable for that purpose, which are gas-tightly welded and sealed. The air space remaining between the snack product and the packaging can be filled with gases like nitrogen or carbon dioxide to give a longer shelf life. Alternatively direct freezing of the filling arranged in the outer casing is also possible. Surface pasteurisation which has already taken place in the baking process is advantageous for packagings which are delivered immediately.

The ingredients of two embodiments of a dough according to the invention are set forth hereinafter, the first embodiment concerning a spicy dough for receiving a spicy filling while the second embodiment concerns a sweet dough for receiving a sweet filling.

Spicy dough

| Ingredients: | Proportion (% by weight): |
|---|---|
| Spicy white bread crumbs | 25.91 |
| Whole egg | 21.59 |
| QimiQ ® sauce base | 10.80 |
| Salt | 0.32 |
| Whole-cream milk | 26.99 |
| Liquid butter | 12.96 |
| Baking powder | 1.08 |
| Ground pepper | 0.02 |
| Freshly chopped parsley | 0.11 |
| Freshly chopped thyme | 0.11 |
| Freshly chopped marjoram | 0.11 |

For preparation firstly the sauce base is stirred with the whole egg. Then the liquid butter is slowly stirred in until a homogeneous mass is formed. The salt is mixed and stirred in with the baking powder. Then the spicy crumbs are added and well stirred. Finally the milk and the herbs are added and stirred, thus resulting in a dough according to the invention. The dough can be left to rise for about 15 minutes and then further processed, that is to say filled into the dough mould and the filling can be arranged on the dough.

Sweet dough

| Ingredients: | Proportion (% by weight): |
|---|---|
| Sweet cookie crumbs | 29.63 |
| Whole egg | 18.52 |
| QimiQ ® sauce base | 12.35 |
| Crystal sugar | 4.94 |
| Whole-cream milk | 18.52 |
| Liquid butter | 14.81 |
| Baking power | 1.23 |

Once again firstly the sauce base is stirred with the whole egg and the liquid butter is slowly stirred in until a homogeneous mass is formed. The sugar is mixed with the baking powder and stirred in. The sweet crumbs are then added and well stirred in. The milk is then added and also stirred. Thereafter the resulting dough can be left to rise for about 15 minutes and then subjected to further processing.

Further details and advantages of the present invention will be described more fully hereinafter by means of the specific description with reference to the drawings.

In the drawings:

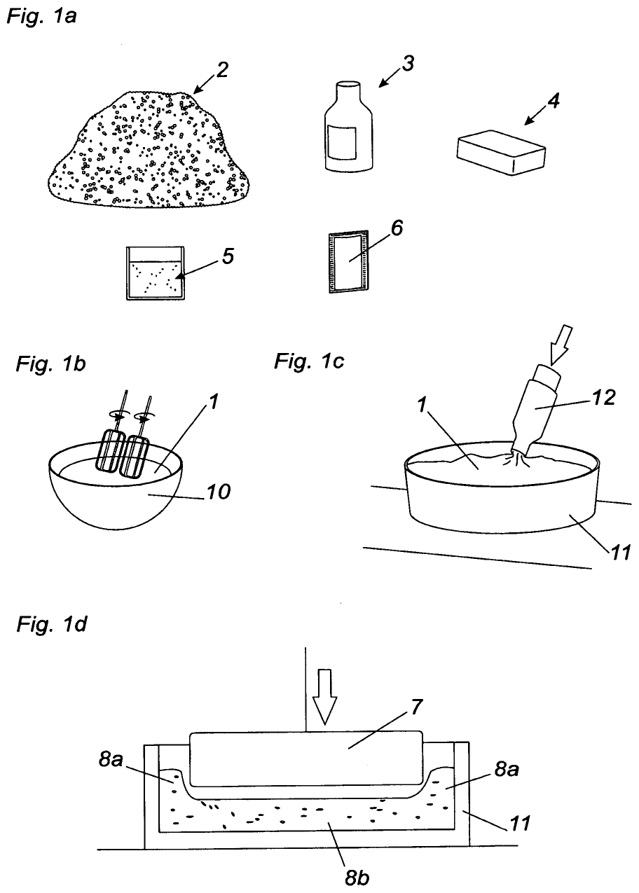

FIGS. 1a to 1e show diagrammatic views of different steps of the method according to the invention,

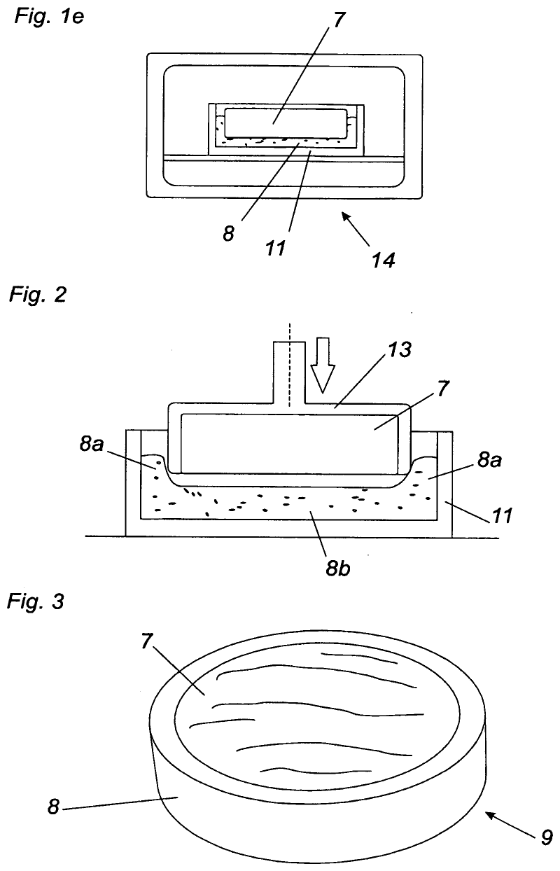

FIG. 2 shows a diagrammatic view of an alternative method step, and

FIG. 3 shows a diagrammatic perspective view of a snack product according to the invention.

FIG. 1a diagrammatically shows the essential ingredients of the dough 1 according to the invention, more specifically crumbs 2, a liquid component 3 in the form of milk, a fat component 4 in the form of butter, an emulsifier 5 in the form of a combination of whole egg and a sauce base comprising cream and native starch and a raising agent 6 in the form of baking powder.

The ingredients are mixed and stirred and kneaded in a machine 10, as diagrammatically shown in FIG. 1b. To avoid excessive gelatinisation the processing time in the machine 10 is kept short.

Subsequently the dough 1 is put into a mould 11 as shown in FIG. 1c. By virtue of the ingredients the dough 1 is sufficiently pasty so that a conventional piston filler 12 can be used for that purpose. In the illustrated case the mould 11 is the peripheral surface of a cylinder and can comprise for example paper or metal. As diagrammatically shown in FIG. 1d the filling 7 is subsequently arranged on the dough 1 which has been filled into the mould 11. The filling 7 can be spicy or sweet depending on the crumbs 1. In the illustrated case a filling 7 is frozen and thus itself serves as a ram, by which the pasty dough 1 is displaced. The mould 11 prevents the dough 1 from escaping so that an outer casing 8 for receiving the filling 7 is formed by arranging the filling 7 therein. By the filling 7 being pushed into the dough 1 the lateral region 8a of the casing 8 is raised, the filling 7 being held thereby jointly with the bottom 8b.

An alternative form of the arrangement of the filling 7 on the dough 1 is diagrammatically shown in FIG. 2. In this case the filling 7 is not frozen. The filling 7 is placed on the dough 1 which has been put into the mould and pushed into the dough 1 by means of a ram 13. As a result the casing 8 is formed, with a lateral casing region 8a for receiving the filling 7.

Finally the dough casing 8 with the filling 7 arranged therein is pre-baked in an oven 14. Depending on the type of oven a temperature of between 180° C. and 225° C. and a time of between 15 and 25 minutes can be provided for that purpose. That is diagrammatically shown in FIG. 1e. The snack product 9 produced thereby can now be packaged and possibly frozen and subsequently delivered.

After heating up or regeneration a ready-to-eat and tasty snack product 9 is now available for final consumption. FIG. 3 diagrammatically shows a perspective view of such a snack product 9. The outer casing 8 comprising the lateral casing region 8a and the bottom 8b forms an upwardly open consumable enclosing case by which the filling 7 is held in the ready-to-eat state of the snack product 9.

1. A dough for the production of an outer casing for a snack product including the ingredients:
crumbs of a previously made bakery product
fat component
liquid component
emulsifier
raising agent
wherein the proportion of the crumbs is between 20% by weight and 60% by weight.

2. The dough according to claim 1, wherein the proportion of crumbs is between 22% by weight and 35% by weight.

3. The dough according to claim 1, wherein the liquid component is added in the form of water, milk, cream or fruit juices or in the form of a combination of said substances.

4. The dough according to claim 1, wherein the fat component is added in the form of butter, margarine or oil.

5. The dough according to claim wherein the emulsifier is added in the form of whole egg or sauce base or a combination of whole egg and sauce base.

6. The dough according to claim wherein the raising agent is added in the form of chemical baking raising agent.

7. The dough according to claim wherein the raising agent is added in the form of baking powder.

8. The dough according to claim wherein the proportion of water in the dough is between 25% by weight and 75% by weight.

9. The dough according to claim 1, wherein the proportion of emulsifier in the dough is between 10% by weight and 45% by weight.

10. The dough according to claim 1, wherein the proportion of fat in the dough is between 8% by weight and 30% by weight.

11. The dough according to claim wherein the proportion of raising agent is between 0.5% by weight and 2% by weight.

12. A snack product with a crisped outer layer produced from the dough according to claim 1 and a filling arranged in the casing.

13. A method of producing a snack product from the dough according to claim including the following steps:
producing a dough
producing a filling
introducing the dough into a mould
arranging the filling on the dough,
wherein an outer casing for receiving the filling is formed in the dough by arranging the filling on the dough.

14. The method according to claim 13, wherein the filling is arranged in the frozen state on the dough.

15. The method according to claim 14, wherein the filling is pushed into the dough introduced into the mould.

16. The method according to claim 13, wherein the mould is in the form of the peripheral surface of a cylinder or prism and comprises paper, metal, ceramic materials or plastic or a combination of said substances.
